(19) United States
(12) Patent Application Publication
(10) Pub. No.: US 2009/0287499 A1
(43) Pub. Date: Nov. 19, 2009

(54) METHOD AND SYSTEM FOR AUTOMATICALLY PROVISIONING A DEVICE AND REGISTERING VEHICLE MODULES WITH A TELEMATICS SERVICES PROVIDER

(76) Inventor: Charles M. Link, II, Atlanta, GA (US)

Correspondence Address: HUGHES TELEMATICS, INC., 41 PERIMETER CENTER EAST, SUITE 400, ATLANTA, GA, 30346, US

(21) Appl. No.: 12/467,960

(22) Filed: May 18, 2009

Related U.S. Application Data
(60) Provisional application No. 61/054,053, filed on May 16, 2008.
(60) Provisional application No. 61/054,084, filed on May 16, 2008.

(51) Int. Cl. G06Q 30/00; G01S 5/00

(52) U.S. Cl. 705/1; 342/357.07

(57) ABSTRACT

Upon crank-up of a newly manufactured vehicle, a TCU seeks a GPS. The TCU queries an equipment information table in a memory and determines if the table is empty. If the table is empty and the TCU detects a GPS signal, the TCU requests equipment information from modules installed in the vehicle, including an ECM, a PCM, a TCM, and other various modules typically installed in vehicles. The information typically includes a module name or type, a module's serial number, version of current software, and for some modules, the VIN of the vehicle. The TCU automatically associates the module equipment information with the VIN gleaned from one of the modules, automatically forms a message with the equipment information including the VIN, and then automatically transmits the message to a telematics services provider's centrally located server. The server automatically associates equipment information, TCU identifier, and subscriber identity information with the VIN.

### CROSS REFERENCE TO RELATED APPLICATION

This application claims priority under 35 U.S.C. 119(e) to U.S. provisional patent application No. 61/054,053 entitled “Telematics control unit activation,” which was filed May 16, 2008, and to U.S. provisional patent application No. 61/054,084 entitled “Telematics System,” which was filed May 16, 2008, both of which are incorporated herein by reference in their entireties.

### FIELD OF THE INVENTION

This invention relates, generally, to telematics systems and devices and, more particularly, to automatically and wirelessly provisioning wireless service for a telematics control unit, and for automatically and wirelessly registering various modules in a vehicle and associating them with the vehicle's VIN in a central database.

### BACKGROUND

Telematics refers to the integrated use of telecommunications devices and systems and information storage, usage, transmitting, receiving, and processing. More simply, telematics refers to sending, receiving and storing, information via telecommunication devices. In addition, telematics devices and system have been applied alongside Global Positioning System (“GPS”) technology integrated with computers and mobile communications technology in automotive information and navigation systems.

Other than the convergence of telecommunications and information processing, the term telematics may also refer to automation of various processes relating to the driving and using of automobiles. For example, a telematics system can report emergency situations to a telematics services provider's central location via a voice telephony call over a wireless communications network, or a message sent electronically over a network, including a wireless communications network and the Internet. Telematics also includes services such as GPS navigation, integrated hands-free cellular telephony, wireless safety communications, and automatic driving assistance and information systems, such as traffic, restaurant, fuel, and emissions information. IEEE standard 802.11p refers to Wireless Access for the Vehicular Environment to facilitate and enhance Intelligent Transportation.

A telematics services provider (“TSP”) typically operates a call center with live operators to respond to emergency calls and to contact the appropriate responders to the emergency. The TSP also typically has a telecommunications operations center (“TOC”), which typically includes a computer server and other networking equipment to connect the server with various networks, such as the internet. A telematics control unit (“TCU”) installed in a vehicle, either at the time of manufacture, or after the vehicle was placed in service, typically contains a GPS portion, a cellular telephony portion, and general computer electronics such as a memory, a general processor, I/O interface, etc., which are coupled to the GPS and to the cellular, or wireless, telephony portion.

A subscriber typically pays a monthly services charge to a TSP. The TSP establishes and maintains a wireless services subscription with a wireless carrier, such as a cellular telephony services provider, so that the I′CU can communicate with the TOC via wireless and internet. This connection also facilitates internet availability and functionality for a subscriber at the TCU. In addition, internet connectivity facilitates a subscriber transmitting and receiving information between his car and a personal computer, or other computer device connected to the internet.

A TSP typically establishes an account with a wireless carrier (can also be referred to as activating or provisioning an account) so that a TCU can communicate across the wireless carrier's wireless (typically cellular) network. After a TCU has been installed in a vehicle, the vehicle's manufacturer, or the retail dealer selling the vehicle, typically obtains a unique identifier of the TCU and unique identifier information corresponding to the wireless telephony portion of the TCU. The unique identifier of the wireless telephony portion typically includes an International Mobile Subscriber Identity (“IMSI”) for mobile units using GSM technology, or a Mobile Subscriber Identifier (“MSID”) for mobile units that use CDMA technology. The TSP may manually obtain the mobile unit's unique identifier and manually forward it to a wireless carrier via a voice telephone call, or writing on a paper form and mailing, or sending via facsimile to the wireless carrier. The wireless carrier begins billing the TSP for wireless service for the TSP.

A TSP typically does not keep track of the location of a given TCU and thus does not know when it has been, or will be, installed in a vehicle. Thus, the TSP typically establishes, or provisions, service for a given TCU soon after receiving notice from the TCU manufacturer that the TCU has been made. However, a wireless carrier begins billing a TSP for wireless service for a given TCU after that TCU has been provisioned, even if the TCU has not been installed in a vehicle. In addition, a given TCU may have been swapped out from a given vehicle for another ICU after the vehicle has been manufactured. The removed I′CU could either sit idle on a shelf, or more likely, be installed in another vehicle owned by someone not paying for a subscription to the TSP services. Also, the various modules in a vehicle may be changed during, or after, manufacture of a vehicle, and manual record keeping procedures typically used do not adequately track the location of a given module.

Thus, the art needs a method and system for automatically provisioning wireless service for a TCU after its corresponding vehicle has been manufactured. Furthermore, the art needs a method and system for deactivating wireless service for a TCU after it has been removed from a vehicle, or otherwise loses association with a subscriber paying for telematics services.

In addition, the art needs a method and system for automatically registering, and centrally maintaining a list of, various modules in a vehicle so that a vehicle manufacturer can glean failure trend data and can investigate inefficient warranty procedures.

### SUMMARY

A method for automatically configuring a telematics control unit for use in a vehicle comprises receiving a unique identifier of the telematics control unit and subscriber identity information that corresponds to the telematics control unit. Typically, a TSP's TOC service receives the unique identifier and the subscriber identity information. The TOC associates the unique identifier of the telematics control unit and the subscriber identity information corresponding to the TCU with a unique identifier of the vehicle. Typically, the unique identifier is a vehicle's vehicle identification number (“VIN”). The method may further comprise receiving equipment information corresponding to a set of vehicle equipment associated with the telematics control unit, and associating the received equipment information with the unique identifier of the vehicle. The vehicle equipment associated with TCU may include various system control modules onboard a vehicle. The vehicle equipment may also include the TCU.

To automatically register equipment modules and update an equipment information table with equipment information of a vehicle, the TCU may seek a wireless signal, for example a GPS signal. If the TCU can tune a GPS signal, it has probably been installed in an assembled vehicle which has left its manufacturing facility (otherwise, the vehicle assembly plant building would probably block, or severely attenuate, GPS signals transmitted from satellites orbiting the earth. After the TCU has detected a GPS signal, the TCU acquires equipment information from equipment devices, for example various system control modules, installed in the vehicle. A TCU also perform this step of acquiring equipment information multiple times during the days, months, and years, after the vehicle it has been installed it has first detected a GPS signal (thus indicating that the vehicle has left its assemble plant). Typically, the TCU re-acquires equipment information from the vehicle after each predetermined number of vehicle crank-ups occur.

After the TCU acquires equipment information whether at first crank-up after leaving a vehicle's assembly plant, or at subsequent crank-ups, the TCU updates the equipment information table with equipment information corresponding to one, or more, equipment devices installed in the vehicle, and wirelessly transmits the equipment information in the table to a central server of a telematics services provider.

A TCU typically comprises a processor circuit coupled to a plurality of vehicle equipment modules. A memory is coupled to the processor. A portion of the memory is configured to store a table of equipment information corresponding to the plurality of vehicle equipment modules. A first wireless circuit coupled to the processor is configured for wirelessly receiving location information corresponding to a present location of the telematics control module. A second wireless circuit is coupled to the processor, which is configured to generate an equipment information message containing the equipment information associated with the VIN of the vehicle. The processor is configured to cause the second wireless circuit to wirelessly transmit the equipment information message to a central server of a telematics services provider.

### BRIEF DESCRIPTION OF DRAWINGS

FIG. 1 illustrates a system for making and installing a telematics control unit in a vehicle and automatically and wirelessly registering the vehicle's module.

FIG. 2 illustrates identifiers and other information stored into a telematics unit during its manufacture.

FIG. 3 illustrates a flow diagram of a method for provisioning a TCU with a wireless carrier.

FIG. 4 illustrates a flow diagram of a method for assembling a vehicle with a TCU.

FIG. 5 illustrates a flow diagram of a method for updating a vehicle equipment information table.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude any such other embodiments, adaptations, is variations, modifications and equivalent arrangements, the present invention being limited only by the claims appended hereto and the equivalents thereof.

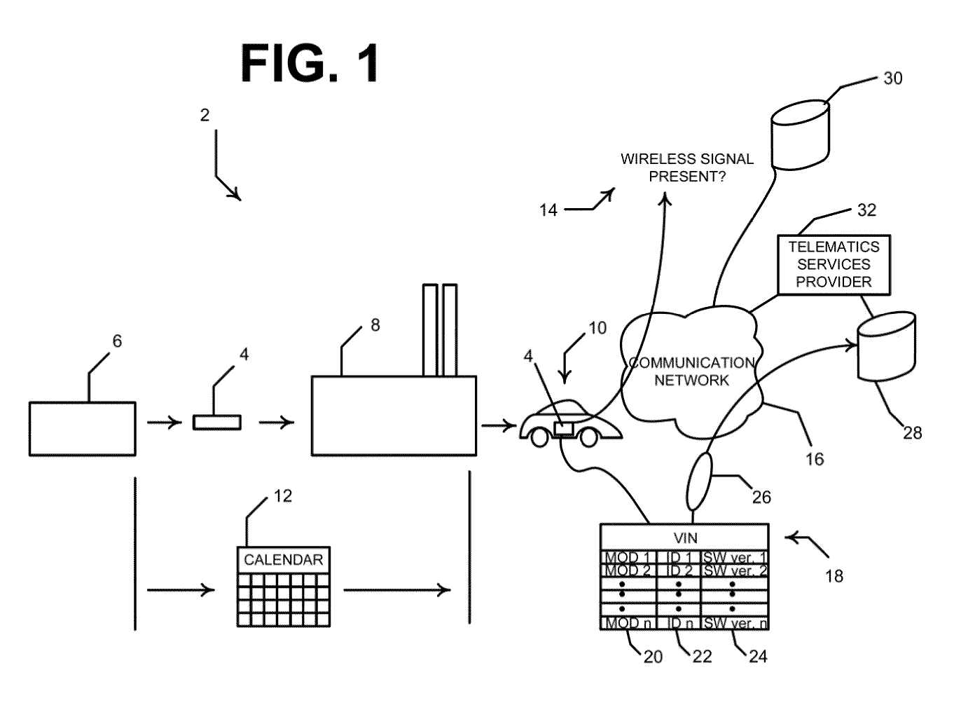

Turning now to the figures, FIG. 1 illustrates a system 2 for wirelessly and automatically registering a vehicle with a telematics services provider (“TSP”). A manufacturer makes a telematics control unit (“TCU”) 4 at a factory 6. After manufacture, TCU 4 travels to an original equipment automobile manufacturer's (“OEM”) assembly plant 8. Although TCU manufacturer 6 and OEM 8 may be collocated, typically, these plants are located in geographically distant locations from one another. Often, the two plants are located in different countries. Thus, the period beginning when TCU 4 leaves plant 6 and then an assembled vehicle 10 with TCU 4 in it leaves plant 8 typically comprises a number of days 12. For purposes of discussion, the period between a TCU leaving plant 4 and then leaving plant 8 in an assembled vehicle 10 is referred to as a registration offset period 12.

A telematics services provider can predetermine provisioning offset period 12, so that after the provisioning offset period elapses following manufacture of a TCU, the telematics services provider's centrally located server automatically establishes an account for the TCU with a wireless services carrier, such as a cellular telephony carrier (e.g., Verizon, Inc. or AT&T, Inc.). When the telematics services provider establishes the account with the wireless carrier, the telematics services provider arranges for predetermined features and bandwidth capacity so that that use of the telematics system conforms to terms previously agreed to by the wireless carrier for subscribers of the telematics services.

For example, a TCU typically comprises a cellular telephone circuit and a global positioning satellite (“GPS”) circuit. Upon crank-up, the TCU seeks a signal compatible with its circuitry. The TCU also seeks a wireless system identifier, sometimes referred to as a SID when used in a CDMA (CDMA-2000) network, or a Mobile Country Code+Mobile Network Code (i.e., MCC+MNC) if used in a Global System for Mobile communications (“GSM”) system device. If a manufacturer makes a TCU for operation according to code division multiple access (“CDMA”), the TCU would not recognize a signal and ID from a GSM transmitter, and vice versa if the TCU was made for use in a GSM network. If the TCU does not detect a compatible SID, MCC, or MCC+MNC combination, then it will not attempt to transmit registration information to the TOC and will return to a deep sleep mode waiting for the next ignition cycle, or vehicle crank-up. However, if the TCU does detect a compatible cellular wireless signal, it will send device and subscriber identity information to the TOC as discussed in more detail below.

Also, following the predetermined provisioning offset period 12 and detection of a GPS signal, TCU 4 may collect information from various control modules installed on vehicle 10. For example, vehicle 10 may include multiple electronic modules such as, for example, an engine control module (“ECM”), a powertrain control module (“PCM”), a transmission control module (“TCM”), a climate control module, a power door locks module, a audio system module, etc. Since each module typically includes similar basic computer circuitry, such as a processor, a memory device, and input and output ports, each module may be generically referred to as an electronic control unit (“ECU”). Each ECU typically has a module name, or type; a unique identifier, or serial number; and current software version. TCU 4 collects this information related to each of the modules onboard vehicle 10 and populates a table 18 with the collected module information. Table 18 associates the vehicle identification number of corresponding to vehicle 10 with the all of the modules identified as MOD 1-MOD n in module name field 20. Identifier and software version fields 22 and 24, respectively, contain the unique identifiers and current software versions of each of modules MOD 1-MOD n. After TCU 4 has built table 18, it formats the table into a message 26 and transmits it across communication network 16 using a wireless link with a wireless provider 30 that generated the signal and the acceptable MCC+MNC or SID that the TCU sensed as being present after it woke up. The TCU transmits the signal to a server 28 operated by telematics services provider 32. One skilled in the art will appreciate that server 28 may be connected to network 16 via a wired, or wireless, link. The ‘cloud’ symbol used in the figure to represent network 16 can represent a wired network such as the internet, and a wireless network such as, for example, a wireless CDMA or GSM cellular network, a GPS network, a Wi-Fi network, and networks using other communication protocols known to those skilled in the art.

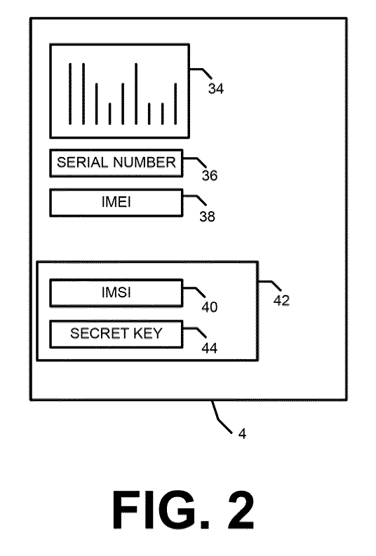

Tuning now to FIG. 2, the figure illustrates typical information stored on a TCU. A bar code 34 corresponding to serial number 36 uniquely identifies the individual TCU. An OEM reader can read bar code 34 during assembly of a vehicle and associate the VIN of the vehicle with the serial number of the unit installed in the vehicle. An International Mobile Equipment Identity (“IMEI”) 38 also uniquely corresponds with a particular TCU, and in some cases a TCU maker may include the IMEI in serial number 36. Preferably, the TCU automatically requests, detects, and stores, the VIN from one of the ECUs, typically, the ECM, when the OEM factory first turns on, or cranks up, the vehicle containing the TCU.

An International Mobile Subscriber Identity (“IMSI”) 40, also a unique number, is associated with, and corresponds to, a particular user's account. In addition, a subscriber identity module (“SIM”) 42 typically contains one, or more, secret keys 44. A TCU manufacturer typically permanently fixes a SIM into a TCU, and the TCU sends SIM information 42 to a telematics services provider via an “electronic data interchange” EDI link. The OEM associates the device identifier, either the serial number 36, the IMEI (or MEID) 38, or both, with the corresponding vehicle's VIN and sends the device identifier and associated VIN to the telematics services provider. Preferably, the TCU transmits VIN, and corresponding TCU device information and SIM information to the telematics services provider automatically when the vehicle is cranked. However, the TCU does not perform a first-time-after-assembly transmission of vehicle equipment information until the TCU detects the presence of a GPS signal. This prevents the TCU from attempting to transmit information while still inside an OEM's factory.

If the TCU has never detected a GPS signal, and cannot detect one, the vehicle is probably still inside a factory building that blocks GPS signals. An OEM may make changes to an ostensibly complete vehicle before it leaves a factory building. Waiting until the TCU detects a GPS signal reduces the likelihood that the TCU will use wireless air-time minutes (which a telematics services provider pays for) to transmit a vehicle's equipment information that may change after the vehicle leaves a factory. When the telematics services provider receives the SIM information 42 and the vehicle TCU identifier information associated with a vehicle's VIN, it creates a new record in a telematics operation center server (such as server 28 shown in FIG. 1) using the VIN as the record identifier. Alternatively, the TOC server may already contain a blank record corresponding to the subscriber identity information contained in the SIM. The telematics services provider indexes the table according to VIN number, and stores future information it receives from a TCU according to VIN. Thus, based on VIN, table 28 at the TOC associates TCU unique identity information, user's (typically the vehicle's purchaser, or owner) account information, and the vehicle module information received in message 26 as shown and described above with respect to FIG. 1.

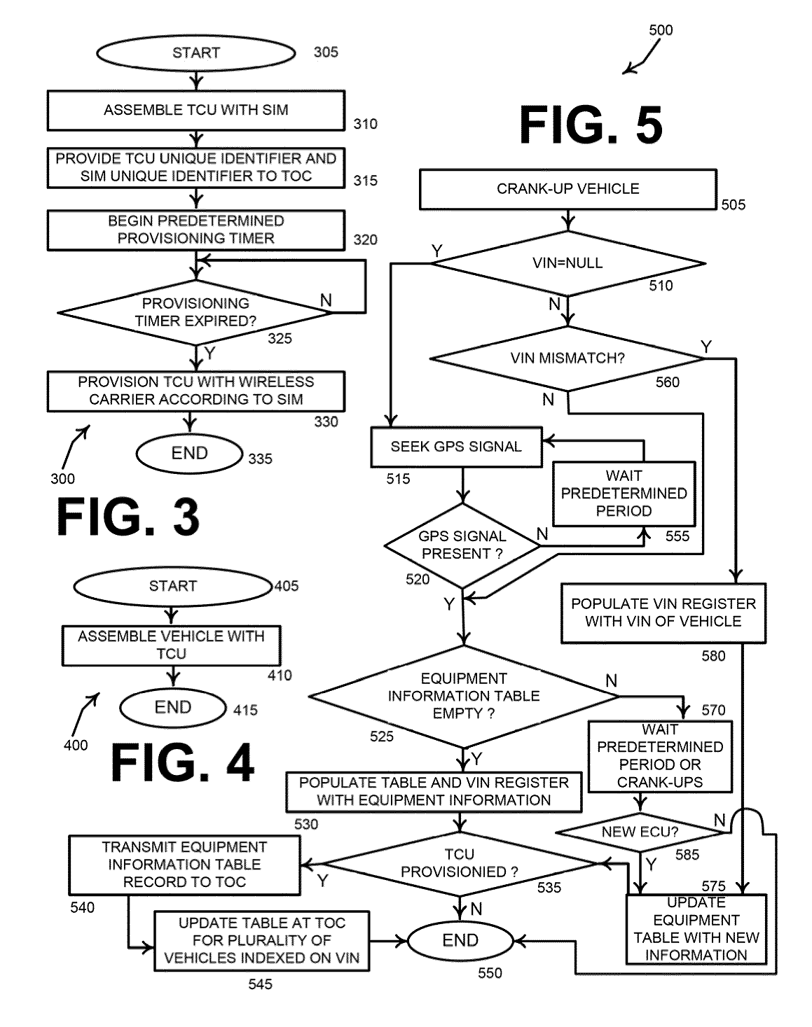

Turning now to FIG. 3, a flow diagram illustrates a method 300 for provisioning a TCU for use over a wireless carrier's network, such as, for example, a cellular telephony network. Method 300 starts at step 305. At step 310, a manufacturer makes a TCU device. During manufacturing, the manufacturer of the TCU installed a SIM in the TCU. Optionally, the manufacturer solders that SIM into the TCU, but a traditional, nonsoldered, SIM card may be installed.

At step 315, the TCU manufacturer provides information to a telematics services provider regarding identifiers of the TCU. For example, the manufacturer may provide the serial number of the device and the associated identifier of the SIM to a telematics services provider's TOC server. The TCU manufacturer may perform step 315 manually, by personnel uploading information from its manufacturing plant to the TOC. Alternatively, the TCU may perform step 315 automatically, while powered up for testing, for example, while still at the plant where the TCU was made. After manufacturing, the manufacturer may set a provisioning timer at step 320. The TCU manufacturer sets the provisioning timer to a predetermined time based on periods for estimated shipment to, and shelf life at, a vehicle manufacturer, for example. After step 325 determines that the timer has counted down, the TOC provisions the TCU by establishing a wireless services account for the TCU based on information uploaded to the TOC at step 315. For example, the wireless provider configures its network equipment to recognize requests for services from the TCU and to provide services in response thereto according to a predetermined rate plan established between the wireless carrier and the telematics services provider. The wireless services carrier establishes the wireless services account for the TCU based on the SIM, and information contained in the TCU. Thus, information in the TCU and SIM, namely a device's identifier and subscriber identify information, such as contained on a SIM in a id GSM device, is associated and linked together at the TOC. Method 300 ends at step 335.

Turning now to FIG. 4, the figure illustrates a flow diagram of an OEM assembling a vehicle with a TCU. Method 400 starts at step 405. At step 410, while manufacturing a vehicle, the OEM installs a TCU in the vehicle as a step in the vehicle assembly process. The TCU typically includes a cellular telephony transceiver circuit portion, a GPS receiver, or transceiver, portion, and a main board with a general processor and memory. The cellular and GPS circuitry portions typically couple electrically with the main circuit board, but may connect wirelessly, or via a cable. The TCU manufacturer optionally solders a subscriber identity module to the main circuit board, or to the cellular circuitry board. A SIM card typically includes an IMSI that can be associated with a subscriber account, and thus a cellular services provider can provision, and bill for, use of a TCU according to a plan a subscriber pays for. The TCU manufacturer also associates a serial number, bar code and IMEI with the TCU itself. Thus, an association is made between the identifier (serial number or IMEI) of the device and a subscriber account by associating the IMEI and IMSI with one another. Furthermore, the OEM may associate the TCU IMEI and the SIM IMSI with a VIN of the vehicle, and may store the associated IMEI, IMSI, and VIN together in a database for future reference. Alternatively, when the TOC automatically establishes an account for a given IMSI, or similar identifier used in CDMA networks, the account information is associated with the VIN of a vehicle the corresponding TCU is installed in when method 500 executes, as described below. Method 400 ends at step 415 after the TCU has been installed in the vehicle.

Turning now to FIG. 5, the figure illustrates a method for updating a table at a telematics services provider's centrally located TOC server. Method 500 starts at step 505 when the vehicle is cranked-up. In an aspect, at step 505, near the end of the assembly process as described in reference to FIG. 4, the OEM manufacturer cranks up the vehicle in which it installed a given TCU. When the vehicle cranks-up (or when the vehicle electrical system has been placed into a Run mode) the vehicle electrical system provides power to the TCU. At step 510, the TCU evaluates a register in a portion of its memory that it uses to store a vehicle's VIN. If the TCU determines that the VIN register is null (typically the case when an OEM installs an unused, or reset, TCU in a newly assembled vehicle) method 500 follows the ‘Y’ branch to step 515.

At step 515 the TCU's general processor instructs the GPS circuitry to seek a GPS signal. At step 520, the general processor determines whether the GPS circuitry detected a GPS signal. If a signal has not been detected, the vehicle has likely not left the OEM factory building, which would most likely block GPS signals from reaching the TCU GPS antenna in the vehicle. Thus, if the TCU general processor determines that the GPS circuit did not detect a GPS signal at step 520, method 500 follows the ‘N’ branch from step 520 and waits a predetermined amount of time at step 555. The predetermined wait time of step 555 may be selected to correspond to the assembly time of a single vehicle at the OEM's factory. Even if the vehicle is placed out of Run mode, the processor can operate the wait timer in a low power state. In addition, any desirable time other than vehicle assembly time may be selected for the time for method 500 to wait at step 555. After waiting the predetermined period at step 555, method 500 returns to step 515.

If the TCU general processor determines that a GPS signal was present at step 520, method 500 advances to step 525 and the TCU general processor determines whether an equipment information table portion in the TCU's memory is empty. If the determination at step 525 is yes, method 500 follows the ‘Y’ branch to step 530. Two conditions were met to arrive at step 530—a GPS signal was detected and the vehicle, with the current TCU, was ‘cranked-up’ for the first time in the presence of a GPS signal (if the vehicle had been cranked-up before with the current TCU was installed, the VIN register would not have been null at step 510). The vehicle could have been cranked up in the factory building that shielded the vehicle's TCU from GPS signals. Furthermore, if the vehicle had been cranked in the presence of a GPS signal with the current TCU was installed, the equipment information table would not have been empty and method 500 would have advanced from step 525 to step 570, as will be discussed further below.

Continuing with the description at step 530, the TCU processor requests equipment information from various electronic device modules, or ECUs, used in the vehicle in which it has been installed. Modules used in a vehicle may include an engine control module (“ECM”), a powertrain control module (“PCM”), a transmission control module (“TCM”), and other various modules typically used in modern vehicles, such as airbag modules, seat belt modules, power window and door modules, audio and video system modules, climate control modules, etc. Each module in a vehicle typically has a module name, module unique identifier, and a software version corresponding to the current version of software, or firmware, it is loaded with.

At step 530, while the vehicle is running, or at least in a Run mode, the various modules respond to the TCU's request for information by providing the information associated with them and stored on their individual memories via a bus, or communication means, such as a controller area network (“CAN”) bus, wireless link, or wired link. The TCU receives the response messages from the various modules and stores the information in an equipment information table in the TCU's memory. The TCU also requests, and receives, the VIN from at least one of the modules, and automatically associates the equipment information received from the modules with the vehicle's VIN number in the equipment information table. The VIN may become part of a record in the TCU memory that stores the equipment information. Or, the name of a file that contains the equipment information may be named with the VIN as part of the file name, or other table identifier.

From the equipment information table record, or file, the TCU creates an electronic equipment information message suitable for transmission over a cellular network, or other similar wireless system, or link. At step 535, the TCU determines whether it has been provisioned as described in reference to FIG. 3, by sending a service request message to the wireless services provider according to its network protocol (for example GSM or CDMA) using information and credentials in the TCU's SIM, or similar information in the case of a CDMA-configured device. If the TCU processor determines at step 535 that the TCU has been provisioned for wireless service, it transmits the equipment information message to a telematics services provider's centrally located TOC server at step 540. At step 545, the TOC server updates its master vehicle equipment information table with information in the electronic message transmitted at step 540, and indexes the master vehicle equipment information table according to VIN. In addition, the TOC verifies that the TCU identifier and IMSI (or similar CDMA identifier) associated with a given VIN has not changed from previous information associated with the VIN. If the TCU, or subscriber identity identifiers, has changed with respect to a given VIN, the TOC updates a subscriber table by associating the new information with the VIN. In addition, the TOC stores the old TCU and subscriber identities associated with the VIN in an unused TCU table, or list. Thus, at any time, the TOC can quickly perform a search for the current information regarding the equipment installed in a vehicle corresponding to a given VIN. And, if the TOC determines at step 545 that a TCU device is no longer associated with a given VIN, the telematics services provider can cancel the subscription with the wireless services provider for the account corresponding to the now unused TCU based on that TCU's SIM information, or similar CDMA information. This provides a method for automatically deactivating a TCU if it has been swapped out and is replaced with another one. Thus, the telematics services provider does not continue paying for a subscription for a TCU that may have been stolen, or reused in a vehicle owned by someone, or an organization, that has not obtained a subscription with the telematics service provider. Method 500 ends at step 550.

Returning to the description of method 500 at step 525, if the TCU processor determined that the equipment information table was not empty, the TCU waits a predetermined amount of time, or a predetermined number of crank-up cycles of the vehicle at step 570. After waiting at step 570, the TCU processor queries the vehicle CAN bus (or other system for communicating with the various ECU modules on the car) at step 585 to determine if new, or different, modules, or software, have been installed since the TCU last performed step 530, or step 575, as described in more detail below. The various modules in the vehicle respond to the query with equipment information as described above with respect to step 530, namely, module name, or other type identifier; module serial number, or other unique identifier; and module software version. The TCU processor stores the result of the query to the TCU memory and then compares the query results to equipment information stored in the equipment information table. If the results of the comparison indicate that new, or different, modules, or new software, have been installed in the vehicle, method 500 follows the ‘Y’ path and at step 575 the TCU updates its equipment information table record with information regarding new equipment, different equipment, or new or different software, that has been installed since the last time the TCU performed step 530, or step 575. From step 575, method 500 advances to step 535 and continues as described above. If the TCU determines at step 585 that the vehicle does not contain new modules, different modules, or new or different software, method 500 ends at step 550.

Returning to step 560, if a VIN mismatch exists, method 500 follows the ‘Y’ branch and advances to step 530. At step 530, the TCU populates, or updates, the is VIN register of the TCU memory and also populates, or updates, the equipment information table with the module names/types, corresponding unique identifiers, and corresponding software versions of the ECU modules used throughout the vehicle.

Steps 575 and 530 differ in that at step 575 the TCU detects differences in information it has stored in the equipment information table from information the CAN bus reports, and the TCU accordingly only updates information that differs. In contrast, at step 530 the TCU updates information for all modules and software installed in the vehicle and also updates the vehicle VIN in the table. This provides for an orderly operation of the TCU and efficient use of wireless bandwidth by waiting at step 570 and then partially updating at steps 575 and 540. For example, if a repair facility has to change out multiple modules before it corrects a problem, wireless bandwidth should not be used to upload an entire equipment information table after every module replacement and vehicle crank-up.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

What is claimed is:

1. A method for automatically configuring a telematics control unit for use in a vehicle, comprising:
receiving at a telematics services provider's centrally located server a unique identifier of the telematics control unit and subscriber identity information that corresponds to the telematics control unit; and
associating the unique identifier of the telematics control unit and the subscriber identity information with a unique identifier of the vehicle.

2. The method of claim 1, further comprising:
receiving equipment information corresponding to a set of vehicle equipment associated with the telematics control unit; and
associating the received equipment information with the unique identifier of the vehicle.

3. The method of claim 1, further comprising:
waiting a predetermined period after manufacture of the telematics control; and
establishing an account with a wireless services provider for the telematics control unit based on the information stored in the subscriber identity information.

4. The method of claim 3 wherein the predetermined period is based on a transport time between the location of manufacture of the telematics unit and the location where the telematics unit will be installed into the vehicle.

5. The method of claim 4 wherein the predetermined period is based oil a predetermined shelf life at the location the telematics unit will be installed into the vehicle.

6. The method of claim 1 further comprising associating customer information corresponding to a purchaser of the vehicle with the vehicle's unique identifier.

7. The method of claim 1 wherein the equipment information includes information corresponding to one, or more, electronic control unit devices installed in the vehicle.

8. The method of claim 7 wherein the electronic control unit devices include the vehicle's engine control module.

9. The method of claim 7 wherein the equipment information includes a serial number of a given electronic control unit device.

10. The method of claim 7 wherein the equipment information includes a version identifier of software that operates one of the electronic control unit devices.

11. The method of claim 1 wherein the unique identifier associated with the vehicle is a vehicle identification number (“VIN”) of the vehicle.

12. A method for automatically and wirelessly updating an equipment information table with equipment information of a vehicle, comprising:
seeking a wireless signal;
acquiring equipment information from equipment devices installed in the vehicle if the wireless signal is found;
updating the table with equipment information corresponding to one, or more, equipment devices installed in the vehicle; and
wirelessly transmitting the equipment information in the table to a central server of a telematics services provider.

13. The method of claim 12 wherein the wireless signal sought is a global positioning satellite signal.

14. The method of claim 12 wherein a telematics control unit in the is vehicle performs the steps of the claim.

15. The method of claim 13 wherein a telematics control unit in the vehicle performs the steps of the claim.

16. The method of claim 12 wherein the equipment information is wirelessly transmitted over a cellular telephony wireless network.

17. The method of claim 12 wherein the equipment information is wirelessly transmitted in a message that includes a unique identifier of the vehicle.

18. The method of claim 12 wherein the unique identifier of the vehicle is a vehicle identification number (“VIN”).

19. The method of claim 13 further comprising determining whether the table is empty, wherein the TCU does not update the table until a predetermined number of days elapses after seeking the wireless signal if the table is not empty.

20. A telematics control unit, comprising:
a processor coupled to a plurality of vehicle equipment modules;
a memory coupled to the processor, the memory being configured with a table to store equipment information corresponding to the plurality of vehicle equipment modules; and
a first wireless circuit coupled to the processor for wirelessly receiving location information corresponding to a present location of the telematics control module.

21. The telematics control unit of claim 20 wherein the wireless module includes a global positioning satellite receiver circuit.

22. The telematics control unit of claim 20 wherein the memory is configured to associate a vehicle identification number (“VIN”) of a vehicle in which the telematics control unit is installed with the equipment information.

23. The telematics control unit of claim 20 further comprising a second wireless circuit coupled to the processor, wherein the processor is configured to generate an equipment information message containing the equipment information associated with the VIN, and wherein the processor is configured to cause the second wireless circuit to wirelessly transmit the equipment information message to a central server of a telematics services provider.

24. The telematics control unit of claim 23 wherein the second wireless circuit includes a cellular telephony transceiver circuit.

25. The telematics control unit of claim 20 further comprising a subscriber identity module that includes a unique identifier of the subscriber identity module that can associate a telematics services subscriber with the telematics control unit.

26. The telematics control unit of claim 25 further comprising a main circuit board coupled to the processor, the memory, the first wireless circuit, and the second wireless circuit, wherein the subscriber identity module has been soldered to the main circuit board.

27. The telematics control unit of claim 25 further comprising a main circuit board coupled to the processor, the memory, the first wireless circuit, and the second wireless circuit, wherein the main circuit board includes a socket coupled thereto for receiving the subscriber identity module.

28. The telematics control unit of claim 20 further comprising a smart card that includes a unique identifier of the smart card that can associate a telematics services subscriber with the telematics control unit.

29. The telematics control unit of claim 28 further comprising a main circuit board coupled to the processor, the memory, the first wireless circuit, and the second wireless circuit, wherein the main circuit board includes a socket coupled thereto for receiving the smart card.
